(19) United States
(12) Patent Application Publication
(10) Pub. No.: US 2026/0094375 A1
(43) Pub. Date: Apr. 2, 2026

(54) GENERATING THREE-DIMENSIONAL (3D) IMAGES FROM IMAGES USING MACHINE LEARNING MODELS

(71) Applicant: Stability AI Ltd, London (GB)

(72) Inventors: Mark Boss, Tübingen (DE); Zixuan Huang, Urbana, IL (US); Aaryaman Vasishta, London (GB); Varun Jampani, Rockland, MA (US)

(21) Appl. No.: 19/341,119

(22) Filed: Sep. 26, 2025

Related U.S. Application Data
(60) Provisional application No. 63/700,024, filed on Sep. 27, 2024.

(51) Int. Cl. G06T 17/20; G06T 15/04; G06T 15/50

(52) U.S. Cl. CPC G06T 17/20; G06T 15/04; G06T 15/50

(57) ABSTRACT

Techniques include receiving an image depicting a first object under a first illumination. The techniques further include generating a three-dimensional mesh object based at least in part on the first object and that represents the first object. The techniques further include generating a texture for the three-dimensional mesh object based at least in part on the three-dimensional mesh object and the first illumination.

### CROSS REFERENCE TO RELATED APPLICATIONS

This application claims the benefit of and priority to U.S. Provisional Application No. 63/700,024, filed Sep. 27, 2024, and titled “Generating Three-Dimensional (3D) Images From Images Using Machine Learning Models,” the content of which is herein incorporated by reference in its entirety for all purposes.

### BACKGROUND

Artificial intelligence models (e.g., generative artificial intelligence models) have gained mainstream attention recently for their capabilities. Despite the impressive progress that has been made in the field of machine learning, existing techniques for training artificial intelligence models and use cases of artificial intelligence models could be further improved.

### BRIEF DESCRIPTION OF THE DRAWINGS

Features, embodiments, and advantages of the present disclosure are better understood when the following Detailed Description is read with reference to the accompanying drawings.

FIG. 1 is a block diagram illustrating an example asset generation system, according to certain embodiments.

FIG. 2 is a block diagram illustrating an example asset generation system, according to certain embodiments.

FIG. 3 is a block diagram illustrating an example triplane generation system, according to certain embodiments.

FIG. 4 is a block diagram illustrating an example material generation system, according to certain embodiments.

FIG. 5 is a block diagram illustrating an example mesh extraction and refinement system, according to certain embodiments.

FIG. 6 is a block diagram illustrating an example differentiable refinement system, according to certain embodiments.

FIG. 7 is a block diagram illustrating an example method of using an asset generation system at inference time, according to certain embodiments

FIG. 8 depicts a block diagram of an exemplary computer apparatus, according to embodiments.

### DETAILED DESCRIPTION

Certain embodiments describe techniques for generating 3D objects from an image. High-quality object meshes of 3D objects are relevant for various use cases in movies, gaming, e-commerce, AR/VR, etc., Challenges exist with generating high-quality 3D object meshes from a single image. For example, existing techniques may produce 3D assets that are not usable for downstream applications (e.g., because of shading from images being reflected in the generated 3D asset, textures not being accurate, shape not being accurate, etc.) or necessitate laborious manual post-processing.

Certain embodiments described herein can reduce light bake-in to 3D assets which improves generated asset color and texture quality. Embodiments can also generate the higher quality assets at faster speeds that other techniques allow.

Another challenge in previous 3D generation models is that they produce meshes with a high vertex count, using vertex coloring to represent object texture. Such an approach makes the resulting 3D assets inefficient to use in applications such as games. For example, some models can take up to 30 seconds for a single asset. Certain embodiments, described herein address such problems by using a highly parallelizable fast box projection-based UV unwrapping technique that can achieve a 0.5 generation time. The asset generation system described herein is trained for mesh generation, incorporating a fast UV unwrapping technique that enables swift texture generation rather than relying on vertex colors. By not using vertex colors, described techniques are capable of encoding finer details while also having a lower polygon count. The vertex displacement also enables estimating smooth shapes, which do not introduce stair-stepping artifacts from marching cubes.

The described techniques also enable machine learning models to learn to predict material parameters and normal maps to enhance the visual quality of the reconstructed 3D meshes. The material property predictions can allows expression of a variety of different surface types.

The techniques disclosed herein can enable rapidly and automatically generating accurate three-dimensional (3D) assets which provides concrete technological improvements to computer graphics systems, rendering pipelines, and computing devices. By producing high-fidelity geometry and surface attributes (e.g., topology, normals, UV Atlas′, material parameters, etc.) with low latency and minimal manual intervention, the disclosed methods improve the quality of generated graphics, reduce computational overhead in downstream processes, and/or enhance the overall performance and reliability of graphics and simulation workloads. These improvements can translate into measurable gains in frame rate stability, memory utilization, cache coherency, energy consumption, and network bandwidth efficiency across a wide range of devices including mobile, embedded, and cloud-based platforms.

A net effect is that a same rendering budget (shader invocations, draw calls, and bandwidth) can generate 3D assets and images including the 3D assets with higher perceptual quality, or alternatively, equivalent visual quality can be achieved with fewer compute cycles, thereby improving the functioning of the computer by reducing load on the GPU, CPU, and/or a network. The ability to generate and update 3D assets on demand can shorten the data path from acquisition to visualization, decreasing time-to-render and motion-to-photon latency in interactive environments such as AR/VR, thereby improving tracking stability and latency.

### I. System Architectures

Systems described herein may include systems for training and using various models (e.g., a diffusion model) and systems. The various models may be used to provide an asset generation system 100 that can generate output based on input.

### A. Inference System Architecture

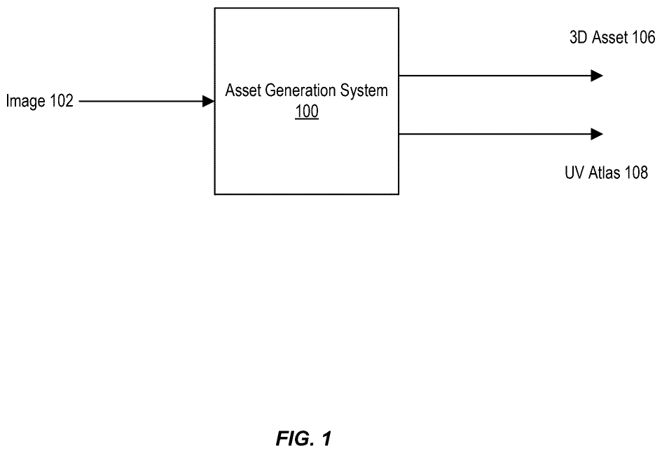

One or more systems and/or models may be included in an inference system. The models may be trained as described herein. FIG. 1 is a block diagram illustrating an example asset generation system 100, according to certain embodiments. The asset generation system 100 may be configured to generate a 3D asset 106 and/or a UV atlas 108 based on an image 102.

The image 102 may be received from a user device, a user interface, system separate from the asset generation system 100, and/or video storage, etc. The image 102 may have been generated by an image generation model (e.g., a text-to-image model). The image 102 may include an image of an object. The object may be a physical object or virtual object. The image 102 may include an image captured from a camera view. The camera view may be a physical camera view (e.g., captured by a camera of a mobile device) or virtual camera view (e.g., an image captured by a virtual camera in a virtual space). The camera view may include a position in a coordinate space. The coordinate space may be two dimensional or three dimensional. The camera view may include an orientation in the coordinate space. The orientation may represent angle(s) of the camera placed at a specific position (e.g., pitch, role, etc.).

The asset generation system 100 may use the image 102 to generate the 3D asset 106 of the object included in the image 102 and/or the UV atlas 108. The 3D asset 106 may be represented by a 3D mesh. The 3D mesh may include a digital representation of one or more surfaces of a 3D object (e.g., the object included in the image), defined by a collection of vertices, edges, and/or faces arranged in a geometric structure. The vertices may specify points in a 3D space. The edges may connect pairs of vertices. The faces may include triangular or quadrilateral faces. The faces can form a visible surface of the object.

The 3D mesh may be represented in various ways, including polygonal meshes, which use flat surfaces to approximate curved geometry, or more complex formats such as subdivision surfaces or parametric representations that allow for smoother contours. The 3D mesh representation can be useful because it provides a flexible and efficient data structure for rendering, manipulating, and/or analyzing 3D objects in digital environments. By using the 3D mesh, graphics systems can be enabled to apply textures, lighting, and/or shading directly to the 3D object's surface, which can enable realistic visualization of the object and the object within an environment. Additionally, 3D mesh representation can be compact (e.g., occupying less storage than other representations of a 3D object) and computationally efficient (e.g., to modify, to perform processing on, and/or to render, etc.), allowing them to be applicable in computer graphics, simulation, animation, gaming, and/or industrial design, etc. The 3D asset 106 may represent an asset that includes colors, but may not in certain embodiments.

The UV atlas 108 can be a type of a 3D atlas/3D mapping. The UV atlas 108 can refer specifically to the mapping of the 3D asset's 106 surface (e.g., geometry) onto a 2D plane using UV coordinates. The “U” and “V” can be the axes of the 2D texture space. The UV atlas 108 can define how the 3D asset's 106 surface is “unwrapped” so that a 2D texture can be laid onto the 3D asset 106 without distortion. The UV atlas 108 may include a flattened representation of the 3D asset's 106 surface that can inform a rendering system with information regarding how to apply images and/or materials to the 3D asset 106.

A 3D map, often referred to as a 3D atlas, is a data structure or coordinate framework that defines how a 3D asset 106 is represented and textured in a digital environment. In computer graphics, a 3D atlas can provide a mapping between a geometry of the 3D asset 106 (its vertices, edges, and/or surfaces) and additional information such as colors, textures, and/or surface properties. The mapping can enable a rendering system to accurately project visual details onto the 3D asset 106 so that the 3D asset 106 appears realistic and/or stylized when displayed. For example, the 3D atlas may contain UV coordinates that specify how a 2D texture image wraps around the curved surfaces of a 3D asset 106. The 3D atlas can prevent a texture from appearing distorted. The 3D atlas can allow applications and rendering engines to efficiently handle multiple 3D assets and textures, reduce memory usage, and/or control visual fidelity. By using a 3D atlas, complex scenes with many objects can be rendered smoothly while maintaining precise alignment between geometry and/or surface details, which can be critical in fields such as gaming, simulation, virtual reality, and/or scientific visualization.

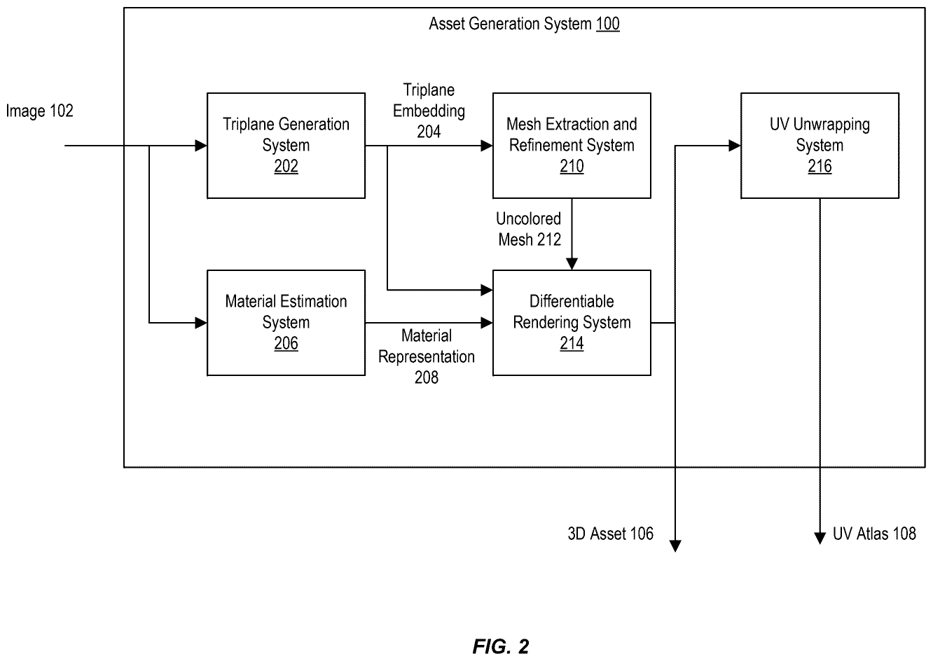

FIG. 2 is a block diagram illustrating an example asset generation system 100 (e.g., asset generation system 100 described above), according to certain embodiments. Asset generation system 100 may include a triplane generation system 202, a material estimation system 206, a mesh extraction and refinement system 210, a differentiable rendering system 214, and/or a UV unwrapping system 216.

The asset generation system 100 may receive an image 102 (e.g., image 102 described above). The image 102 may be received by the triplane generation system 202 and/or the material estimation system 206. The asset generation system 100 may use image 102 to generate a 3D asset 106 (e.g., the 3D asset 106 described above) and/or a UV atlas 108 (e.g., UV atlas 108 described above).

The triplane generation system 202 may include a machine learning model. The machine learning model may include a feed-forward model. A feed-forward model/feed-forward Neural Network (FNN) is a type of artificial neural network in which information can flow in a single direction (e.g., from an input layer through hidden layers to an output layer) without loops or feedback. The feed-forward model may be used for pattern recognition tasks such as image classification. The machine learning model may include a feed-forward fast 3D reconstruction model. The triplane generation system 202 may include a large transformer-based network that outputs a triplane embedding 204 including a 3D representation of the image 102. The triplane embedding 204 may include a volumetric representation of an object included in the image 102. The triplane embedding 204 may represent an object included in the image 102 using a vector space representation, The triplane embedding 204 may have a high dimensionality. For example, in certain embodiments, the triplane embedding 204 dimensionality is 64×64, greater than 64×64, 384×384, etc.

The triplane embedding 204 may be converted into a mesh using a Marching Cubes (MC) algorithm. The MC algorithm can cause ‘stairstepping’ artifacts, which can be reduced by increasing a volume resolution. However, increasing volume resolution may come at a cost of increasing a computational overhead by an amount (e.g., a large amount). Embodiments described herein can avoid increasing the computational overhead by the amount. Embodiments may use an efficient architecture for generating the triplane embedding 204 and can produce meshes using Deep Marching Tetrahedra (DMTet) with learned vertex displacements and normal maps, which can result in smoother mesh surfaces.

The material estimation system 206 may generate a material representation 208. The material estimation system 206 may generate the material representation 208 based on the image 102. The material estimation system 206 may generate the material representation 208 that indicates one or more materials of an object included in image 102. The material representation 205 may indicate one or more types of materials of a surface of the object included in image 102. The material representation may be transmitted to the differential rendering system 214.

The mesh extraction and refinement system 210 may generate a uncolored mesh 212 based on the triplane embedding 204. The mesh extraction and refinement system 210 may generate the uncolored mesh 212 using one or more machine learning models and/or portions of a machine learning model. The mesh extraction and refinement system 210 may generate a prediction of vertex offsets and/or surface normals, which can help in generating smoother 3D asset shapes with fewer mesh extraction artifacts. The uncolored mesh 212 may be transmitted to the differential rendering system 214. In certain embodiments, the uncolored mesh 212 is output from the asset generation system 100. The uncolored mesh 212 may be presented by a user interface, stored in a 3D asset datastore (e.g., local or remote), and/or may be transmitted to another system (e.g., client device, server, etc.).

The differentiable rendering system 214 may receive the uncolored mesh 212, the triplane embedding 204, and/or the material representation 208. The differentiable rendering system 214 may generate the 3D asset 106 based on the uncolored mesh 212, the triplane embedding 204, and/or the material representation 208. The differential rendering system 214 may include one or more machine learning models.

The UV unwrapping system 216 may receive the 3D asset 106 from the differentiable rendering system 214. The UV unwrapping system 216 may generate the UV atlas 108. The UV atlas 108 may be output from the asset generation system 100. The UV atlas 108 may be stored (e.g., locally and/or remotely), may be transmitted to a user device, caused to be presented on a user interface, may be transmitted to another system (e.g., client device and/or server, etc.). The UV unwrapping system 216 may perform processing that includes performing a fast UV-unwrapping. After the UV unwrapping, world positions and occupancy may be baked into to the UV atlas 108, which may be used for querying an albedo a normal.

The processing performed by the UV unwrapping system 216 may take 150 milliseconds or less. UV unwrapping is traditionally a computationally intensive process. Previous techniques require several seconds for UV unwrapping, which is impractical when aiming for faster (e.g., sub-second) generation speeds. To address this inefficiency, certain embodiments can use a Cube projection-based unwrapping technique. An advantage of the Cube projection-based unwrapping technique is it can be parallelizable with each face of the mesh independently deciding which cube face to project onto, based on its surface normal. Initially, an output mesh may be aligned based on most dominant axes with the cube projection coordinate system. After each mesh face selects the appropriate cube direction, potential occlusions may be addressed. For example, if a 3D object of a person is being generated and the person object has a right arm in a pants pocket, the right torso of the person may be partially occluded by the right arm when being viewed from the right side of the right. Without managing occlusions, different faces could share the same UV coordinates, leading to artifacts in the texture. Occlusion can be detected in the UV atlas 108 by performing 2D triangle-triangle intersection tests. Triangles may be filtered by their proximity to the respective triangle centers to make the process efficient. If an intersection is detected, the intersecting triangles can be sorted based on their depth in a plane, keeping the first intersection and marking the others for reassignment to different UV atlas areas. In certain embodiments, the first intersection is placed in a first portion (e.g., top third) of the UV atlas and the second intersection is placed in a second portion (e.g., the bottom left) of the UV atlas. The remaining triangles can be organized into a grid in a third portion (bottom right) of the UV atlas. In certain embodiments, each island may be rotated to minimize shading seams by following radial z tangent orientation. Each triangle face of the mesh may be assigned to a position in the UV atlas 108.

In certain embodiments, world positions and occupancy data with UV-unwrapping may be included in the UV atlas 108. Such embodiments can allow a query for the world positions within a chart from the triplane embedding 204 and decode the albedo and surface normals into additional textures. In certain embodiments, the world-space normal map can be transformed into a tangent-space normal map using the tangent and bitangent vectors.

Margins may be added to the UV atlas 108 to prevent visible seams at UV island borders. Adding margins may be achieved through an iterative process: in each iteration, performing a 3×3 partial convolution based on occupied areas, using valid regions of a kernel. A 3×3 max pooling operation can be used to expand the occupied regions of the UV atlas 108, placing mean values in newly expanded areas while preserving the original areas. The iterative process can ensure that the textures smoothly blend outwards.

The 3D asset 106 and/or the UV atlas 108 may include an indication of the metal representation and include information about the 3D asset and/or the UV atlas 108 in a GLB file (e.g., a binary file format for 3D models saved in the GL transmission format). The GLB file may be used for rendering and use in various applications. The GLB file may be under 1 megabyte in size and may be generated in less than 1 second and/or less than 0.5 seconds.

The UV unwrapping technique described herein may use projection mapping, allowing each face to independently select a projection, enabling parallelization. A naive approach could lead to the same UV coordinates being assigned to different vertices due to occlusions. Certain embodiments can identify potential overlaps from occlusions on the 2D mapped surfaces and relocate them to different areas within the UV atlas 108. Any remaining areas are placed in the a n area (e.g., a bottom right area) of the UV atlas 108. The IV unwrapping technique described herein can minimize distortion and ensures most surfaces are preserved in a connected area.

Embodiments described herein that use the UV unwrapping system 216 may capture more details and represent more details in the UV atlas 108 compared to previous techniques despite the capability of the UV unwrapping system 216 to include fewer polygons (e.g., 10× reduction in polygon count).

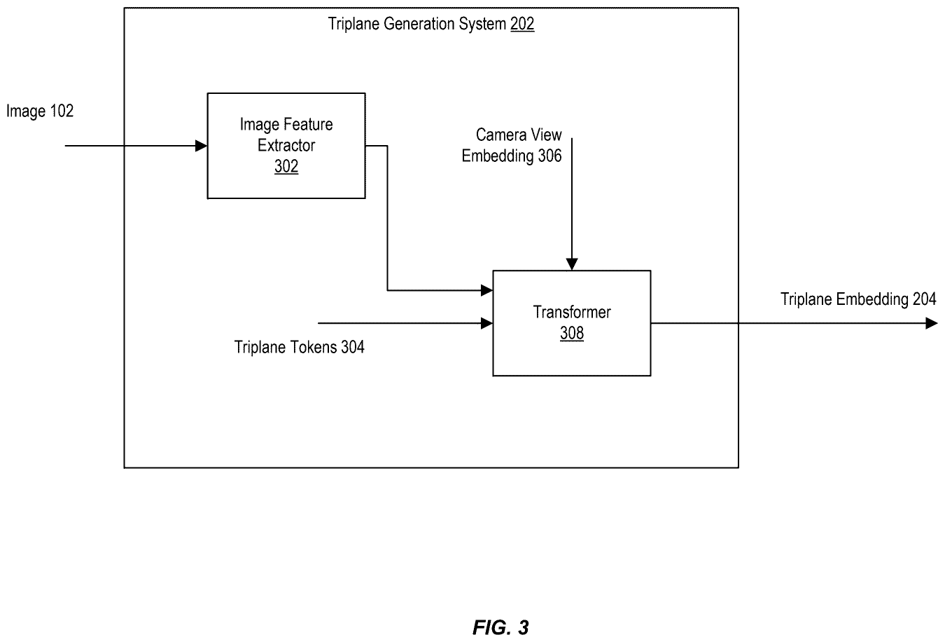

FIG. 3 is a block diagram illustrating an example triplane generation system 202 (e.g., triplane generation system 202 described above), according to certain embodiments. The triplane generation system 202 may generate a triplane embedding 204 (e.g., triplane embedding 204 described above) based on (e.g., based at least in part on) an image 102 (e.g., image 102 described above). The triplane generation system 202 may include an image feature extractor 302 and/or a transformer 308.

The image feature extractor 302 may include an encoder, a variational auto encoder (VAE) encoder and/or a Contrastive Language-Image Pretraining model (CLIP), a Deeper Into Neural Networks (DINO) model, a DINOv2 model, etc. The image feature extractor 302 may be trained to encode the image 102 into an image embedding. The image feature extractor 302 may have been used by a VAE system to train a decoder to generate an image based on an embedding. The image feature extractor 302 may generate an image embedding and transmit the image embedding to the transformer 308. The image embedding may include one or more image tokens.

The transformer 308 may receive one or more triplane tokens. The tokens may include noise. The triplane tokens may include random noise. The triplane tokens may be determined during training of the transformer 308.

The transformer 308 may receive a camera view embedding. The camera view embedding may include an embedding of a camera position, a camera orientation, and/or a camera focal length. The camera view embedding and the image embedding may be used to condition the transformer 308.

The transformer 308 may contribute to enabling representing high-frequency and/or high contrast textures from the image 102. The encoding output by the transformer 308 may include an embedding size of 384×384. The larger embedding space can enable embodiments to generate textures with fewer artifacts than smaller embedding sizes that are not able to accurately model textures. In certain embodiments, complexity of the transformer 308 operations is linear concerning the input size because self-attention on higher resolution triplane tokens is avoided.

In certain embodiments, the generated triplane embedding 204 is 96×96 with 1024 channels. In certain embodiments, the generating triplane embedding 204 includes 40-channel features at a 384×384 resolution.

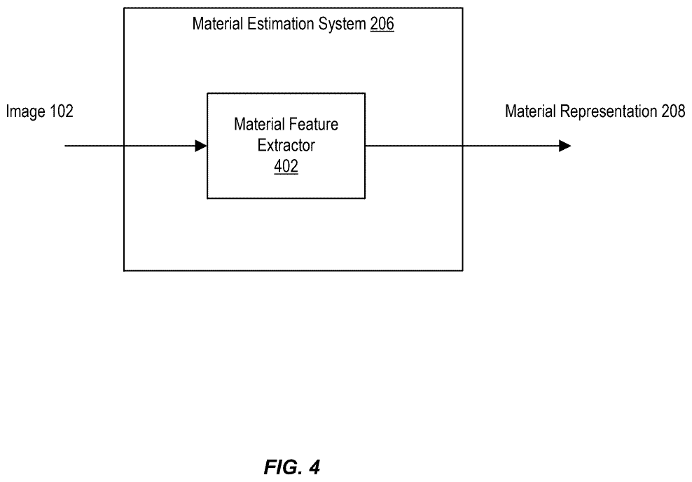

FIG. 4 is a block diagram illustrating an example material estimation system 206 (e.g., the material estimation system 206 described above), according to certain embodiments. The material estimation system may generate a material representation 208 (e.g., material representation 208 described above) based on an image 102 (e.g., image 102 described above).

The material estimation system may include a material feature extractor 402. The material feature extractor 402 may generate one or more material indications. A material indication may indicate characteristics about one or more materials includes in the image 102. The material indications may be represented by the material representation 208. The material representation 208 may be represented by a vector (e.g., by an embedding).

The material feature extractor 402 may include an encoder, a variational auto encoder (VAE) encoder and/or a Contrastive Language-Image Pretraining model (CLIP), etc. The material feature extractor 402 may be trained to encode an image into an image embedding. The material feature extractor 402 may have been used by a VAE system to train a decoder to generate an image based on an embedding. The material feature extractor 402 may generate the material representation 208 and transmit the material representation 208 to a differentiable rendering system (e.g., differentiable rendering system 214 described herein). The material representation 208 may indicate one or more material features of an object included in the image 102. In certain embodiments, a first material extractor is used to determine a first material feature (e.g., roughness) and a material feature extractor is used to determine a second material feature (e.g., metallic).

In certain embodiments, the material representation 208 indicates one or more material features of the image 102. For example, the material representation 208 may indicate that the object included metallic portions and/or rough portions. A low roughness may indicate a reflective material. A high roughness may indicate a less reflective material than a low roughness material. The material representation can be modeled as a distribution. Modeling as a distribution can give the material estimation system a capability to express uncertainty.

Generated 3D assets from previous feed-forward techniques often look dull when they are rendered using different illuminations. This can be due to the lack of explicit material properties in output generations, which can influence the light reflection. Accordingly, certain embodiments address such challenges by predicting non-spatially varying material properties. In certain embodiments, a single value indicating metallic-ness and another single value indicating roughness of the object is determined.

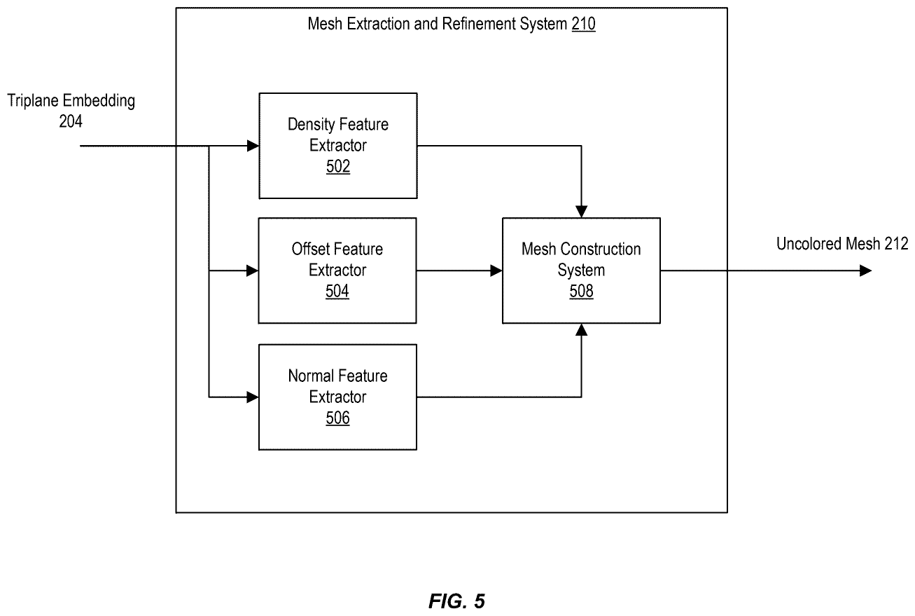

FIG. 5 is a block diagram illustrating an example mesh extraction and refinement system 210 (e.g., the mesh extraction and refinement system 210 described above), according to certain embodiments. The mesh extraction and refinement system 210 may generate an uncolored mesh 212 (e.g., uncolored mesh 212 described above) based on a triplane embedding 204 (e.g., triplane embedding 204 described above). The mesh extraction and refinement system 210 may include a density feature extractor 502, an offset feature extractor 504, a normal feature extractor 50, and/or a mesh construction system 508.

The density feature extractor 502 may receive the triplane embedding 204. The density feature extractor 502 may receive the triplane embedding 204 in parallel and/or process the triplane embedding 204 in parallel with the offset feature extractor 504 and/or the normal feature extractor 506.

The density feature extractor 502, offset feature extractor 504, and/or the normal feature extractor 506 may include an encoder, a variational auto encoder (VAE) encoder, etc. The encoder may be trained to encode the triplane embedding 204 into a processed embedding (e.g., generate the processed embedding based on the triplane embedding). The density feature extractor 502 may have been used by a VAE system to train a decoder to generate an image based on an embedding. The encoder may generate the processed embedding and transmit the image embedding to the mesh construction system 508. The density feature extractor 502, the offset feature extractor 504, and the normal feature extractor 506 may include different models and/or different parameters than any other feature extractors described herein. The density feature extractor 502 may include a multi-layer perceptron (MLP).

The density feature extractor 502 may receive the triplane embedding 204. The density feature extractor 502 may generate a density embedding based on the triplane embedding 204. The density feature extractor 502 may extract a mesh of the triplane embedding 204 using a first Deep Marching Tetrahrdra (DMTet). The density embedding can enable a smooth surface to be generated using the uncolored mesh. The density feature extractor 502 may include a small network (e.g., a MLP) to interpret normal features included in the triplane embedding 204. The density feature extractor 502 may determine density features in each position in space in the triplane embedding 204.

The offset feature extractor 504 may receive the triplane embedding 204. The offset feature extractor 504 may generate an offset embedding (representing vertex offsets that can reduce artifacts from the tetrahedral grids) based on the triplane embedding 204. The offset feature extractor 504 may extract a mesh of the triplane embedding 204 using a second Deep Marching Tetrahrdra (DMTet). The offsets can enable a smooth surface to be generated using the uncolored mesh 212. The offset feature extractor 504 may include a small network (e.g., a MLP) to interpret offset features included in the triplane embedding 204. The offset feature extractor 504 may determine offset features in each position in space in the triplane embedding 204.

The normal feature extractor 506 may receive the triplane embedding 204. The normal feature extractor 506 may generate a normal embedding (e.g., representing world space vertex normals that can add details to flat mesh triangles) based on the triplane embedding 204. The normal feature extractor 506 may extract a mesh of the triplane embedding 204 using a third Deep Marching Tetrahrdra (DMTet). The normal embedding can enable a smooth surface to be generated using the uncolored mesh. The normal feature extractor 506 may include a small network (e.g., a MLP) to interpret normal features included in the triplane embedding 204. The normal feature extractor may determine normal features in each position in space in the triplane embedding 204. The normal embedding may indicate which direction a surface is in. The normal embedding may a smoothing of a surface even if the underlying surface is more coarse.

The mesh construction system 508 may generate the uncolored mesh 212. The uncolored mesh 212 may be generated by combining the embeddings generated by the density feature extractor 502, the offset feature extractor 504, and/or the normal feature extractor 506. The uncolored mesh 212 may include a mesh representation of the object included in an image represented using the triplane embedding 204. The uncolored mesh 212 may represent a size and shape of the object. The uncolored mesh 212 may be transmitted to a differential rending system (e.g., differential rendering system 214 described above). The meshes generated using DMTet may include learned vertex displacements and normal maps, resulting in smoother mesh surfaces.

In certain embodiments, split decoders (e.g., small split decoders) are implemented for the offset feature extractor 504 and the normal feature extractor 506. The split decoders can further improve performance and accuracy.

Given that the normal predictions are initially unreliable, we stabilize the training by using spherical linear interpolation (slerp) between the geometry normals and predictions. In certain embodiments, the slerp is during the initial 5,000 training steps.

To regularize the mesh estimation, one or more training losses may be used: a normal consistency loss, a Laplacian smoothness loss, and a vertex offset regularization. For supervising the normal prediction, certain embodiments use a geometry normal replication loss=1−n•\hat{ }n, where • is the dot product and a normal smoothness loss to ensure the smoothness of normal predictions in 3D. The geometry normal replication loss can be achieved by adding a small offset e around a query location x. The loss is then defined as =(\hat{ }n(x)−\hat{ }n(x+ϵ))².

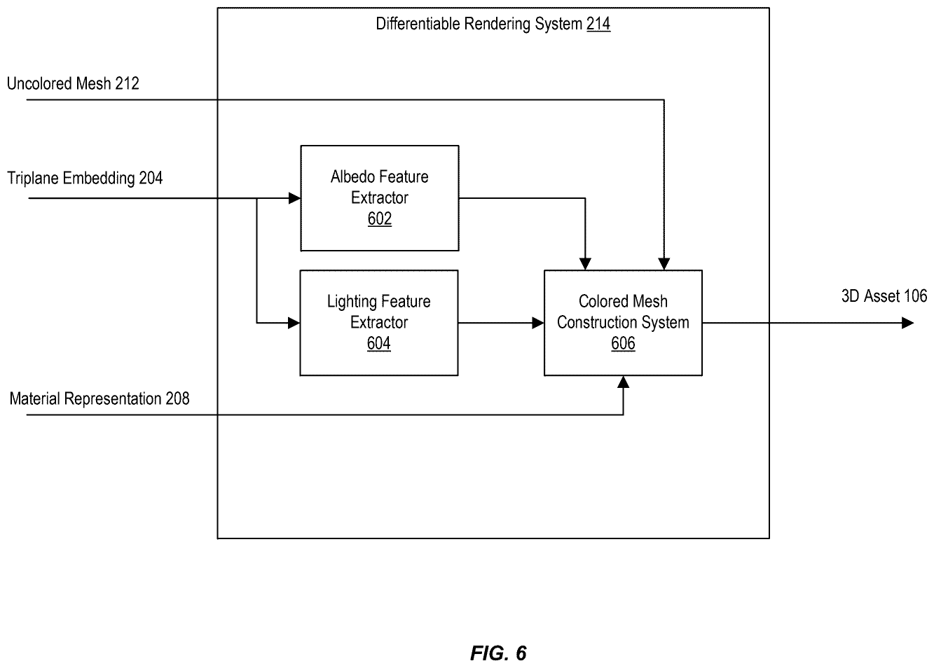

FIG. 6 is a block diagram illustrating an example differentiable rendering system 214 (e.g., differentiable rendering system 214 described above), according to certain embodiments. The differentiable rendering system 214 may generate a 3D asset 106 (e.g., 3D asset 106 described above) based on an uncolored mesh 212 (e.g., uncolored mesh 212 described above), a triplane embedding 204 (e.g., triplane embedding 204 described above), and/or a material representation 208 (e.g., material representation 208 described above). The differentiable rendering system 214 may include an albedo feature extractor 602, a lighting feature extractor 604, and/or a colored mesh construction system 606.

The albedo feature extractor 602 may receive the triplane embedding 204. The albedo feature extractor 602 may generate an albedo embedding based on the triplane embedding 204. The albedo feature extractor 602 may extract a mesh of the triplane embedding 204 using a third Deep Marching Tetrahrdra (DMTet). The albedo feature extractor 602 may include a small network (e.g., a MLP) to interpret albedo features included in the triplane embedding 204. The albedo feature extractor 602 may determine albedo features in each position in space in the triplane embedding 204. The albedo embedding can represent a color at each point in the triplane embedding 204.

The lighting feature extractor 604 may receive the triplane embedding 204. The lighting feature extractor 604 may generate a lighting embedding based on the triplane embedding. The lighting feature extractor 604 may extract a mesh of the triplane embedding 204 using a third Deep Marching Tetrahrdra (DMTet). The lighting feature extractor 604 may include a small network (e.g., a MLP) to interpret lighting features included in the triplane embedding 204. The lighting feature extractor 604 may determine lighting features in each position in space in the triplane embedding 204.

Having shadows or other illumination effects in a given input image is common. Most existing works bake these effects into textures, making the resulting 3D assets less usable. Having consistent lighting helps in easy integration into graphics pipelines. The lighting feature extractor 604 can determine where illumination is on an object represented by the triplane embedding 204 and decompose the illumination and reflective properties by incorporating explicit illumination and a differentiable shading model using Spherical Gaussians (SG). The illumination model may enable training on regular multi-view datasets. Decompose the illumination can assist in outputting homogeneous objects without shadows.

In certain embodiments, 96×96 resolution triplanes from a transformer (transformer 308) are received by the differentiable rendering system and passed through two convolutional neural network (CNN) layers, followed by a max pool and final MLP with three hidden layers and a feature dimension 512 for all layers. Lighting feature extractor 604 can output the grayscale amplitude values for 24 SGs with a Softplus activation to ensure positive values. The axis and sharpness values for these SGs remain fixed and are set up to cover the entire sphere. The amplitude values allow for implementation of a deferred physically based rendering approach Certain embodiments include using a lighting demodulation loss during a training phase. The lighting demodulation loss function can enable the lighting on an object with an entirely white albedo to closely matches the luminance of the input image. The demodulation loss can enforce consistency between the learned illumination and the lighting conditions observed in the training data. The demodulation loss can be seen as a bias to resolve the ambiguity between appearance and shading.

The colored mesh construction system 606 may use the albedo embedding, the lighting embedding, the uncolored mesh 212, and/or the material representation 208 to generate the 3D asset 106. In certain embodiments, the lighting feature extractor 604 is not used. The 3D asset 106 may include the uncolored mesh 212 with color applied based on the albedo embedding and corrections for the lighting and the materials so that the true color is reflected instead of darker colors from shadows, lighter colors from reflections, lighter colors from light, etc. The 3D asset 106 may include a colored mesh without any lighting applied.

After the 3D asset 106 and/or a UV atlas (e.g., UV atlas 108) is generated by embodiments described herein, a rendering system may render the 3D asset. The 2D asset may be rendered with color and/or texture. The rendering system may dynamically apply lighting to the rendered object.

### A. Training System Architecture

An asset generation system (e.g., asset generation system 100 described above) may include one or more machine learning models. The machine learning models may be trained by a model training system. The machine learning models may be trained using training samples so that the models can learn to generate output based on input received by the models.

Training a feed-forward model (e.g., transformer 308) can involve adjusting weights of neurons of the feed-forward model to minimize error between a predicted output and an actual output. This process can be performed using backpropagation and gradient descent. Training the feed-forward model can involve training with multi-view image datasets without explicit 3D supervision.

The asset generation system may be pre-trained on a Neural Radian Field (NeRF) task. Following pre-training, mesh training may be used, replacing the NeRF rendering with differentiable mesh rendering and/or SG-based shading. Given the introduction of light estimation, using larger batch sizes may aid convergence. In certain embodiments, training is initiated with a batch size of 192 and a rendering resolution of 128×128, training for 10,000 steps. In the subsequent stage, the batch size may be reduced to 128 and resolution may be increased to 256×256, continuing for 20,000 steps. A final training stage may involves 80,000 steps at a 512×512 resolution with a batch size of 96. The loss functions may remain consistent across all mesh training stages. In certain embodiments, image-based metrics are partially or exclusively used to compare rendered and shaded reconstructions with the GT image. These can include Mean square error (MSE) loss and Learned Perceptual Image Patch Similarity (LPIPS) losses. A mask loss can be used between the GT mask and the predicted opacity, defined as an MSE loss. Three loss formulations for the rendering, mesh regularization, and shading can be defined as follows:

$${ℒ}_{render} = {\underbrace{{λ}_{MSE}}}_{10} {ℒ}_{MSE} + {\underbrace{{λ}_{LPIPS}}}_{2} {ℒ}_{LPIPS} + {\underbrace{{λ}_{Mask}}}_{10} {ℒ}_{Mask} \qquad ( 1 )$$

$${ℒ}_{mesh} = {\underbrace{{λ}_{Laplacian}}}_{0.01} {ℒ}_{Laplacian} + {\underbrace{{λ}_{Nrm Consistency}}}_{0.001} {ℒ}_{Nrm consistency} + {\underbrace{{λ}_{Offset}}}_{0.1} {ℒ}_{Offset} \qquad ( 2 )$$

$${ℒ}_{shading} = {\underbrace{{λ}_{Nrm repl}}}_{0.2} {ℒ}_{Nrm repl} {\underbrace{{λ}_{Nrm smooth}}}_{0.02} {ℒ}_{Nrm smooth} + {\underbrace{{λ}_{Demod}}}_{0.01} {ℒ}_{Demod} \qquad ( 3 )$$

The total loss is defined as:

$$ℒ = {ℒ}_{render} + {ℒ}_{mesh} + {ℒ}_{shading} \qquad ( 4 )$$

For pre-training a material feature extractor (e.g., material feature extractor 402), a subset of 3D objects may be selected with Physics Based Rendering (PBR) material properties from the synthetic training dataset and rendered them under different illuminations and viewpoints. In certain embodiments, directly regressing material values leads to training collapse, where the network always predicts a roughness value of 0.5 and a metallic value of 0. As a remedy, a probabilistic prediction approach can be used, where predicting the parameters of a Beta distribution and minimizing the log-likelihood during training is performed. The remedy stabilizes the training by allowing for uncertainty in this ambiguous material estimation task and prevents the collapse observed with direct regression. During inference and training of the asset generation system, the distribution may not be sampled but the mode of the distribution may be calculated. We implement a material estimation system (e.g., material estimation system 206) by first passing an image (e.g., image 102) through a frozen CLIP image encoder to extract semantically meaningful latents and pass them through two separate MLPs with three hidden layers and 512 width to output the parameters for the distributions.

### II. Method

The processing performed using the inference system architecture described above with respect to FIGS. 1-6 may be implemented using an inference time method. Examples of such methods are described below with respect to method 700.

The processing depicted in method 700 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 700, and other FIGS. and described herein are intended to be illustrative and non-limiting. Although method 700, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in methods 700, and other FIGS., may include a greater number or a lesser number of steps than those depicted in the respective FIGS.

### B. Method of Inference

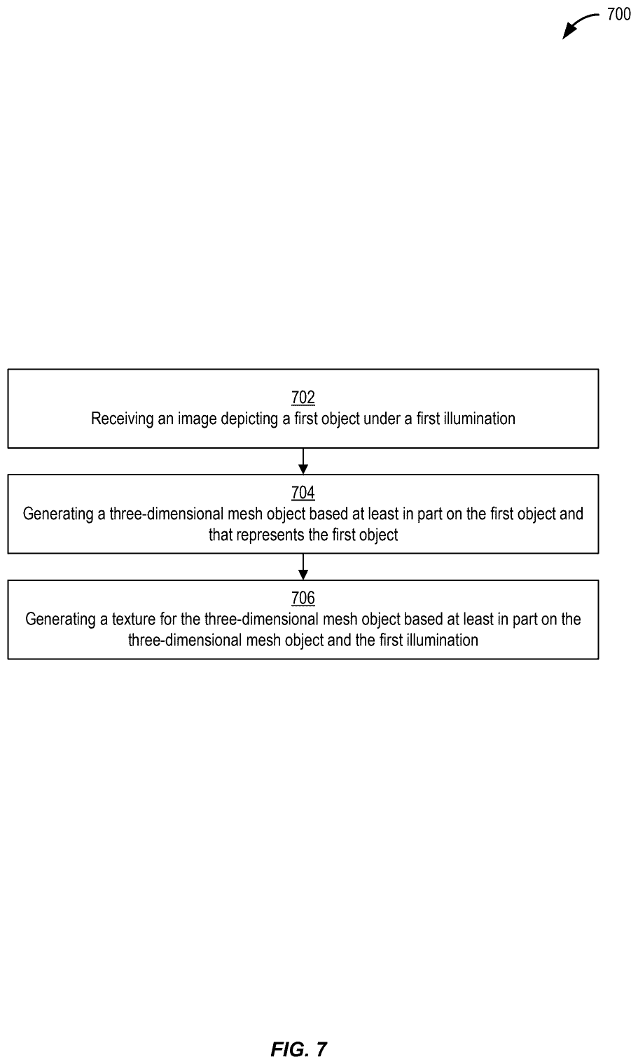

FIG. 7 shows an example method 700 for using an asset generation system (e.g., asset generation system 100), according to certain embodiments of the present disclosure. The method may be performed by the asset generation system 100 described above.

At S702, an image (e.g., image 102 described above) may be received. The image may depict a first object. The first object may be depicted under a first illumination. The illumination may cause bright areas of the object, shadows, different color appearances, etc. The image of the first object may present the first object from a first camera view (e.g., camera position and orientation).

At S704, three dimensional-mesh object (e.g., 3D asset 106 described above) may be generated. The three dimensional-mesh object may be generated based on (e.g., based at least in part on) the first object. The three dimensional-mesh object may represent the first object included in the first image. The three dimensional-mesh object may be generated by using the asset generation system and/or components included in the asset generation system as described above.

The three dimensional-mesh object may include a texture. The texture may be defined by a UV atlas (e.g., UV atlas 108 described above). The texture for the three-dimensional mesh object may reflect the first object absent the first illumination (e.g., reflect how the first object would look in even illumination and reflect true colors of the object without shadows and/or reflections). The texture may be generated based on an illumination amplitude. The illumination amplitude may represent illumination on the object. The illumination amplitude may be determined using at least one spherical gaussian (SG) illumination map and the triplane embedding. The illumination amplitudes are described further herein and may be generated by a feature extractor (e.g., lighting feature extractor 604).

As described herein, the three dimensional mesh object may be generated based at least in part on using an offset feature extractor (e.g., offset feature extractor 504 described above) that determines at least one offset feature associated with the first object and the three-dimensional mesh object. In certain embodiments, the generation of the three-dimensional mesh object is generated in less than 30 seconds, less than 10 seconds, less than 5 seconds, less than 1 second, and/or less than 0.5 seconds.

At S706, the texture may be generated for the three-dimensional mesh object. The texture may be generated based at least in part on the three-dimensional mesh object and the first illumination. The texture may be generated by a UV unwrapping system (e.g., UV unwrapping system 216 described above).

In certain embodiments, method 700 may further comprise presenting the three-dimensional mesh object from a second camera view that is different from the first camera view. For example, the object may be shown from a back of the object using the three-dimensional mesh object even though the first object included in the image was only shown from a front.

After the three-dimensional mesh object and the texture are generated, they may be used for generating an asset for digital entertainment. For example, the asset of digital entertainment may include an object to be rendered in a movie, show, video game, AR environment, and/or VR environment, etc. The three-dimensional mesh object may have an illumination applied to it after the three-dimensional mesh object is generated. For example, the three-dimensional mesh object may be included in a video game along with a sun object that emits light that interacts (e.g., reflect off of) the three-dimensional mesh object. The illumination applied to the three-dimensional mesh object may be different and/or independent of the illumination applied to the first object. The three-dimensional mesh object and the second illumination may be output as a three-dimensional object file (e.g., for use in a video game).

In certain embodiments, a triplane embedding (e.g., triplane embedding 204 described above) is generated. The triplane embedding may include a resolution of at least 300 pixels by 300 pixels. The triplane embedding may be used to generate the three-dimensional mesh object and the texture (e.g., as described with respect to FIG. 2).

In certain embodiments, the three-dimensional mesh object is generated based on using at least an albedo feature extractor (e.g. albedo feature extractor 603) and a lighting feature extractor (e.g., lighting feature extractor 604).

### III. Computer System

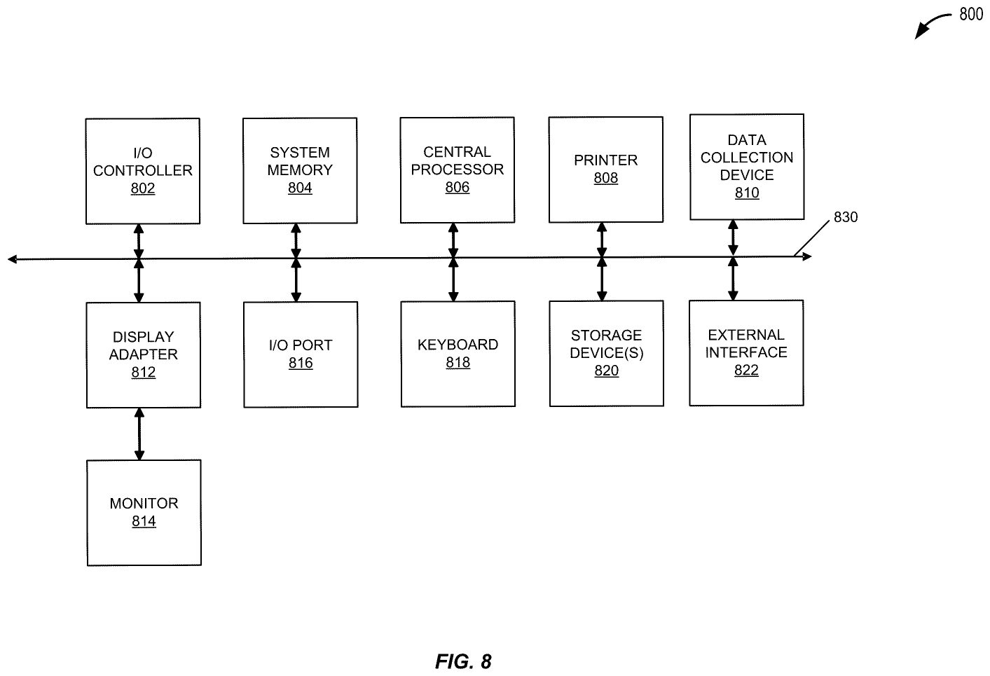

Any of the computer systems mentioned herein may utilize any suitable number of subsystems. Examples of such subsystems are shown in FIG. 8 in computer system 800. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 8 are interconnected via a system bus 830. Additional subsystems such as a printer 808, keyboard 818, storage device(s) 820, monitor 814 (e.g., a display screen, such as an LED), which is coupled to display adapter 812, and others are shown. Peripherals and input/output (I/O) devices, which couple to I/O controller 802, can be connected to the computer system by any number of means known in the art such as input/output (I/O) port 816 (e.g., USB, FireWire®). For example, I/O port 816 or external interface 822 (e.g., Ethernet, Wi-Fi, etc.) can be used to connect computer system 800 to a wide area network such as the Internet, a mouse input device, or a scanner. The interconnection via system bus 830 allows the central processor 806 to communicate with each subsystem and to control the execution of a plurality of instructions from system memory 804 or the storage device(s) 820 (e.g., a fixed disk, such as a hard drive, or optical disk), as well as the exchange of information between subsystems. The system memory 804 and/or the storage device(s) 820 may embody a computer readable medium. Another subsystem is a data collection device 810, such as a camera, microphone, accelerometer, and the like. Any of the data mentioned herein can be output from one component to another component and can be output to the user.

A computer system can include a plurality of the same components or subsystems, e.g., connected together by external interface 822, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a,” “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

1. A system comprising:
one or more storage media storing instructions; and
one or more processors configured to execute the instructions to cause the system to:
receive an image depicting a first object;
generate a three-dimensional mesh object based at least in part on the first object, wherein the three-dimensional mesh object represents the first object;
generate a representation of one or more material features of the first object, wherein the representation indicates at least one of a roughness feature or a metallic feature of the first object; and
generate a texture for the three-dimensional mesh object based at least in part on the three-dimensional mesh object and the representation of one or more material features of the first object.

2. The system of claim 1, wherein the first object is presented from a first camera view; and
wherein the system further comprises processors configured to execute the instructions to further cause the system to present the three-dimensional mesh object from a second camera view that is different from the first camera view.

3. The system of claim 1, wherein the texture for the three-dimensional mesh object reflects the first object absent an illumination reflected by the image depicting the first object, and wherein the texture is represented using a texture space applicable to the three-dimensional mesh object.

4. The system of claim 1, wherein the execution of the instructions further cause the system to generate a triplane embedding,
wherein the three-dimensional mesh object is generated based at least in part on inputting the triplane embedding to an offset feature extractor that determines at least one offset feature associated with the first object and the three-dimensional mesh object.

5. The system of claim 1, wherein the three-dimensional mesh object and the texture are used for generating an asset for digital entertainment.

6. The system of claim 1, wherein the three-dimensional mesh object is generated in less than 10 seconds.

7. The system of claim 1, wherein the three-dimensional mesh object absent the texture and the texture are generated in less than 5 seconds.

8. The system of claim 1, wherein the execution of the instructions further cause the system to:
apply a first illumination to the three-dimensional mesh object that is different than a second illumination the first object was depicted under; and
output a representation of the three-dimensional mesh object and the first illumination as a three-dimensional object file.

9. The system of claim 1, wherein the execution of the instructions further cause the system to:
generate, by encoding the image, a triplane embedding that includes a resolution of at least 300 pixels×300 pixels; and
generate the three-dimensional mesh object and the texture based at least in part on the triplane embedding.

10. The system of claim 9, wherein the execution of the instructions further cause the system to:
generate, by inputting the triplane embedding to a feature extractor, an illumination amplitude; and
generate the texture based at least in part on the illumination amplitude.

11. The system of claim 10, wherein the illumination amplitude is determined using at least one spherical gaussian illumination map and the triplane embedding.

12. The system of claim 1, wherein the execution of the instructions further cause the system to generate the three-dimensional mesh object based at least in part on using at least an albedo feature extractor, a lighting feature extractor, a density feature extractor, and a normal feature extractor.

13. A method comprising:
receiving an image depicting a first object;
generating a three-dimensional mesh object based at least in part on the first object wherein the three-dimensional mesh object represents the first object;
generating a representation of one or more material features of the first object, wherein the representation indicates at least one of a roughness feature or a metallic feature of the first object; and
generating a texture for the three-dimensional mesh object based at least in part on the three-dimensional mesh object and the representation of one or more material features of the first object.

14. The method of claim 13, wherein the first object is presented from a first camera view; and
wherein the method further comprises: presenting the three-dimensional mesh object from a second camera view that is different from the first camera view absent the texture.

15. The method of claim 13, wherein generating the three-dimensional mesh object is further based at least in part on the representation of one or more material features of the first object.

16. The method of claim 13, further comprising:
applying a first illumination to the three-dimensional mesh object that is different than a second illumination the first object was depicted under; and
outputting a representation of the three-dimensional mesh object and the first illumination as a three-dimensional object file.

17. The method of claim 13, further comprising:
generating, based at least in part on inputting the image and a camera view embedding into a transformer-based neural network, a triplane embedding that includes a resolution of at least 300 pixels×300 pixels; and
generating the three-dimensional mesh object and the texture based at least in part on the triplane embedding.

18. One or more non-transitory computer-readable storage media storing instructions that, upon execution by one or more processors of a system, cause the system to perform operations comprising:
receiving an image depicting a first object;
generating a three-dimensional mesh object based at least in part on the first object, wherein the three-dimensional mesh object represents the first object;
generating a representation of one or more material features of the first object, wherein the representation indicates at least one of a roughness feature or a metallic feature of the first object; and
generating a texture for the three-dimensional mesh object based at least in part on the three-dimensional mesh object and the representation of one or more material features of the first object.

19. The computer-readable storage media of claim 18, wherein at least one of the roughness feature or the metallic feature is represented using a distribution that reflects an uncertainty.

20. The computer-readable storage media of claim 18, wherein the execution of the instructions cause the system to perform operations further comprising:
applying a first illumination to the three-dimensional mesh object that is different than a second illumination the first object was depicted under; and
outputting a representation of the three-dimensional mesh object and the first illumination as a three-dimensional object file.
